(19) United States
(12) Patent Application Publication
(10) Pub. No.: US 2026/0242099 A1
(43) Pub. Date: Aug. 20, 2026

(54) CONTAINER HAVING A FIBER-BASED NECK THREAD AND POLYMERIC CAP

(71) Applicant: The Procter & Gamble Company, Cincinnati, OH (US)

(72) Inventors: Els Julia Kristien LESAGE, IEPER (BE); Sven PROESMANS, BRASSCHAAT (BE); Greetje Emerance E. NEUJENS, EDEGEM (BE); Thierry Christian Francis DAGNELIE, WATERLOO (BE); Rainer SCHARRENBERG, MARBURG (DE)

(21) Appl. No.: 19/539,964

(22) Filed: Feb. 13, 2026

Related U.S. Application Data
(60) Provisional application No. 63/758,425, filed on Feb. 14, 2025.

(51) Int. Cl. B65D 41/04; B32B 27/08; B65D 1/02; B65D 23/08; B65D 65/46

(52) U.S. Cl. CPC B65D 41/0414; B32B 27/08; B65D 1/0215; B65D 23/0821; B65D 1/0246; B65D 65/466

(57) ABSTRACT

Containers including a fiber-based neck thread mated to a polymeric cap that can store liquids with minimal to no leakage during manufacturing, shipping, and ultimate usage by a user. The fiber-based neck thread and polymeric cap employ features that create a good closure seal. The containers can be recycled in many geographies and municipal waste systems.

### FIELD

The present disclosure generally relates to containers having a fiber-based bottle finish mated to a polymeric closure cap to effectuate a sealed closure. The containers can hold liquids and solids with minimal to no leakage during manufacture, shipping, and ultimate usage by a user.

### BACKGROUND

The design and manufacture of paper and other fiber-based containers for holding and dispensing liquids have greatly improved over the past few years. Paper containers typically comprise molded pulp as the base material and a barrier coating material. Even with incorporation of a barrier layer, the containers can still have an unacceptable amount of leakage when used for storing liquids. One source of the leakage is at the interface of the container finish and a closure cap. To address this, one design approach utilized a hybrid approach wherein a polymeric container neck is mated with a fiber-based container body so that traditional designs and configurations of sealing used with plastic bottles and caps could be employed with fiber-based container bodies. While this can improve leakage through the closure area, manufacturing challenges can occur when making such a hybrid container. Moreover, there is a desire to minimize the amount of plastic in containers due to environmental concerns. In some areas recycling requires that a total container (bottle and cap) have a high fiber material to plastic material ratio.

Therefore, there is a continuing need to provide a container comprising an even higher percentage of fiber-based material and that is capable of storing and dispensing liquids with minimal to no leakage. Extending the fiber-based substrate from a container body into the neck region, and managing the amount of barrier coating material can help achieve sustainability and recycling goals.

### SUMMARY

Improved containers comprising bottles with fiber-based finishes mated to polymeric closure caps are provided. In one form, the container comprises a fiber-based bottle having a body and a neck. The neck includes an inner neck surface and an opposing outer neck surface, a neck thread, and a neck distal portion that is adjacent to the neck thread and that terminates into a neck edge and bottle opening. The neck thread that is formed such that a portion of the outer surface is curvilinear. The neck is formed with a fiber-based material layer and a polymeric material layer covering the fiber-based material to establish the inner neck surface and the neck edge. A polymeric cap covers the opening, and includes a cap thread for engaging the neck thread and a channel for engaging the neck distal portion. The polymeric material layer comprises a first polymeric material, and the polymeric cap comprises a second polymeric material that is different than the first polymeric material.

In another form, the container comprises a fiber-based bottle having a body and a neck. The neck includes an inner neck surface and an opposing outer neck surface, a neck thread, and a neck distal portion that is adjacent to the neck thread and that terminates into a neck edge and bottle opening. The neck thread that is formed such that a portion of the outer surface is curvilinear. The neck is formed with a fiber-based material layer and a polymeric material layer covering at least a portion of the fiber-based material. A polymeric cap covers the opening, and includes a cap thread for engaging the neck thread and a channel for engaging the neck distal portion. The channel employs a cantilever seal flange. A seal overlap is defined by the difference, when the polymeric cap is removed from the bottle, between a channel width dimension and a neck distal portion thickness dimension. The seal overlap is at least 0.1 millimeters.

In yet another form, the container comprises a fiber-based bottle having a body and a neck. The neck includes an inner neck surface and an opposing outer neck surface, a neck thread, and a neck distal portion that is adjacent to the neck thread and that terminates into a neck edge and bottle opening. The neck thread that is formed such that a portion of the outer surface is curvilinear. The neck is formed with a fiber-based material layer and a polymeric material layer covering at least a portion of the fiber-based material. A polymeric cap covers the opening, and includes a cap thread for engaging the neck thread and an expandable channel for engaging the neck distal portion. The channel includes a channel width at its narrowest point, when the polymeric cap is removed from the bottle, that is less than 0.8 millimeters.

In a fourth form, the container comprises a fiber-based bottle having a body and a neck. The neck includes an inner neck surface and an opposing outer neck surface, a neck thread, and a neck distal portion that is adjacent to the neck thread and that terminates into a neck edge and bottle opening. The neck thread that is formed such that a portion of the outer surface is curvilinear. The neck is formed with a fiber-based material layer and a polymeric material layer covering at least a portion of the fiber-based material. A polymeric cap covers the opening, and includes a cap thread for engaging the neck thread and a channel for engaging the neck distal portion. The neck distal portion includes an inner diameter having a first ovality and an outer diameter having a second ovality. The first ovality is different from the second ovality.

### BRIEF DESCRIPTION OF THE DRAWINGS

The above-mentioned and other features and advantages of the present disclosure, and the manner of attaining them, will become more apparent and the disclosure itself will be better understood by reference to the following description of example forms of the disclosure taken in conjunction with the accompanying drawings, wherein:

FIG. 1 is a perspective view of an exemplary container bottle provided herein;

FIGS. 2 and 3 are partial cross-sectional views of bottle finishes provided herein;

FIG. 4 is a perspective view of an exemplary container cap provided herein;

FIG. 5 is a partial cross-sectional view of the container cap shown in FIG. 4;

FIG. 6 is a perspective view of an exemplary container of the present invention;

FIG. 7 is a partial cross-sectional view of the container shown in FIG. 6;

FIG. 8 is a partial cross-sectional view of another exemplary bottle finish configuration; and

FIG. 9 is a partial cross-sectional view showing a seal overlap as described herein.

### DETAILED DESCRIPTION

Reference within the specification to "form(s)", "aspect(s)", "embodiment(s)" or the like means that a particular material, feature, structure and/or characteristic described in connection with the form/aspect/embodiment is included in at least one form/aspect/embodiment, optionally several forms/aspects/embodiments, but it does not mean that all forms/aspects/embodiments incorporate the material, feature, structure, and/or characteristic described. Furthermore, materials, features, structures and/or characteristics may be combined in any suitable manner across different forms/aspects/embodiments, and materials, features, structures and/or characteristics may be omitted or substituted from what is described. Thus, forms/aspects/embodiments described herein may comprise or be combinable with elements or components of other forms/aspects/embodiments despite not being expressly exemplified in combination, unless otherwise stated or an incompatibility is stated.

“Bottle” as used herein is broadly defined as a vessel to contain liquids, solids, or combinations thereof, and not limited to a particular geometry or size, or having specific features not called out the appended claims.

“Compressed pulp”, “molded pulp”, “fiber-based” are herein to be understood as a mixture of water, fibers (especially paper or wood fibers, potentially recycled material) and optionally a binding agent. The mixture is shaped, pressed and dried. While cellulosic pulp fibers are particularly suitable for the containers of the present invention, other fibers are contemplated.

“Layer” as used herein means a sheet, quantity, or thickness of material. The layer can be continuous, discontinuous, or even exist in a pattern. The layer need not be separable intact from an adjacent material, surface or body.

Every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

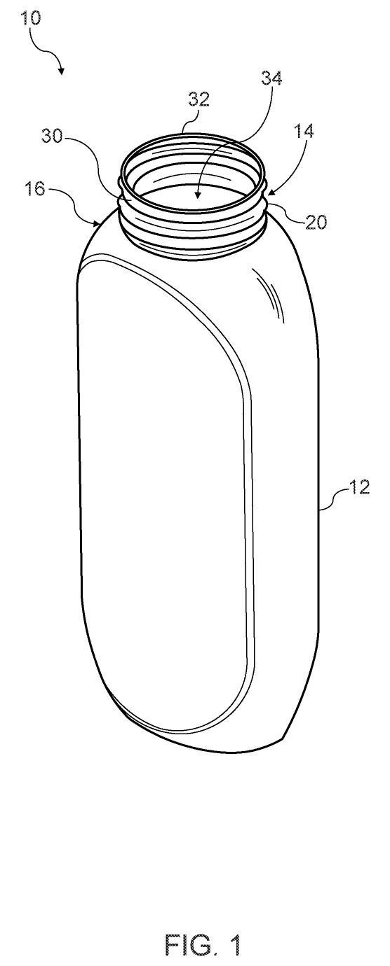

Improved containers are provided herein, the containers generally comprise a bottle and a closure cap. FIG. 1 shows an exemplary bottle 10 that includes a body 12, a neck 14, and a shoulder region 16 therebetween. While bottle 10 comprises a rectangular cross-section with outwardly bowed front and rear walls, other geometries are contemplated herein, including, but not limited to, a circular, oval or polygonal cross-section (e.g. rectangle, square, octagonal, etc.), or some combination of those cross-sectional shapes. Exemplary bottle sizes can range from about 200 milliliters to about 3000 milliliters.

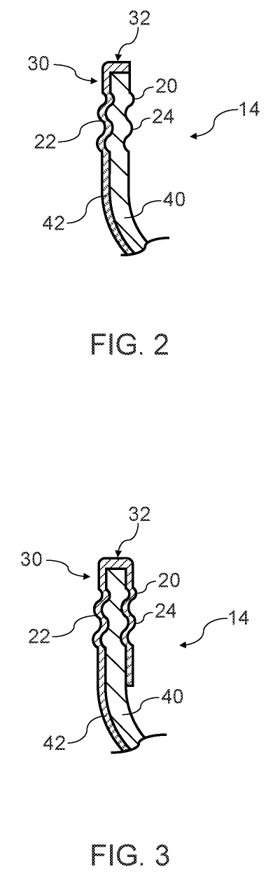

Referring to FIGS. 1 and 2, neck 14 includes a neck thread 20 and neck distal portion 30 that terminates into a neck edge 32 that defines a bottle opening 34. The neck distal portion can be offset from or adjacent to the neck thread. In one form and as illustrated in FIGS. 1 and 2, the neck thread can be formed such that both an inner neck surface 22 and an outer neck surface 24 are curvilinear. Molding the neck thread in this manner can result in more defined and uniform fiber-based threads to help in ensuring good closure sealing. This is in contrast to many plastic container neck threads which have a straight inner neck surface.

A partial view of one side of neck 14 is shown in FIG. 2. As shown, the bottle comprises a first layer 40 and a second layer 42. Second layer 42 can cover first layer 40 over the entirety of the bottle (interior, exterior, or both), or alternatively, cover only portions of first layer 40. By way of example only, FIG. 2 shows second layer 42 covering first layer 40 to define an inner neck surface 22 and neck edge 32, while FIG. 3 shows second layer 42 also covering a portion of first layer 40 to define outer neck surface 24. As part of the examples shown in FIGS. 2 and 3, second layer 42 extends further to cover first layer 40 over the entire interior of the bottle.

First layer 40 is a fiber-based material that provides the overall stability of the bottle. First layer 40 can comprise a cellulosic fiber material such as compressed or molded pulp. A variety of different pulp fibers can be used. In one aspect, the pulp fibers are sourced from trees and can be softwood, hardwood, or a blend of the two. Virgin pulp fibers, recycled pulp fibers, and mixtures thereof are acceptable. In one embodiment, the fiber-based material layer can comprise post-consumer recycled fibers. The fiber-based material may comprise fibers other than pulp fibers; for example, regenerated cellulosic fibers (such as rayon, cellulose acetate, or lyocell fibers), polyvinyl alcohol fibers, polylactic acid fibers, and starch fibers.

An exemplary pulp fiber blend comprises a first pulp and a second pulp. The first pulp comprises 65-90% of a pulp having a Schopper-Riegler number according to ISO 5267-1 of below 48, and the second pulp comprises 10-35% of a pulp having a Schopper-Riegler number of 60-90. At least 50% of the first and second pulp blend comprises softwood pulp.

Second layer 42 comprises a polymeric material that can provide a barrier function when the containers store liquid compositions and/or help create a good seal with a container closure. The polymeric material used for second layer 42 is not limited. For example, the polymeric material may comprise a thermoplastic selected from polyolefins such as those including polyethylene, polypropylene, or copolymers thereof, polyamides, and polyesters. The polymeric material may also comprise synthetic biodegradable materials like polyvinyl alcohol or polysaccharides (e.g., cellulose), which are considered biodegradable according to the standard DIN EN 13432. The polymeric material may have a post-consumer recycled content of at least 30% by weight.

The polymeric materials may be petroleum-based or bio-based. In one form, the polymeric material layer comprises a bio-based polymer (e.g., polyethylene) content of at least 80% by weight, wherein the bio-based is defined according to the standards ASTM D 6866, CEN/TS 16137 and ISO 16620. The bio-based polymer can include high density polyethylene, polyethylene terephthalate, polyethylene furanoate, polyethylene isosorbide terephthalate, polylactide, polybutylene succinate, poly-s-caprolactone, polyhydroxyalkanoate, or polyhydroxybutyrate.

The polymeric material layer is typically added to the fiber-based layer after the fiber-based layer has been molded into its desired configuration. As such, the polymeric material can be applied as a powder to the fiber-based material layer. Polymeric powder particles can have an average size of from about 1 microns to about 200 microns; for example, from about 5 microns to about 100 microns, or from about 10 microns to about 50 microns. Powder application can occur through an electrostatic high-voltage process, for example an ionization process or a corona process, or a triboelectric or an electrokinetic friction process, followed by baking the bottle in a sintering furnace, wherein during the sintering process a crystalline phase grows by spherulitic crystallization and the crystallization growth occurs by adding nucleating agent and maintaining the temperature between the glass transition temperature (TG) and the crystallite melting point (Ts). This can allow particularly high crystalline proportions to form and a homogeneous layer of polymeric material to be created through sintering. Optionally, the polymeric material layer can be applied by roto-molding, dip coating, spray coating, or combinations thereof.

One suitable powder-coating method is described in U.S. Patent Application No. US 2024/0167228 A1, incorporated herein by reference. A spraying gun or other spraying device charges the polymeric powder prior to or during deposition. The polymeric particles can be charged by corona charging which applies a negative or positive charge to the particles allowing them to strongly adhere to desired portions of the fiber-based material layer.

The polymeric material expediently may have a light barrier against UV light, visible light and infrared light, which causes a transmission reduction of at least 30% between a wavelength of 350 and 550 nm, whereby the light barrier is preferably realized by coloring the polymeric material. This avoids potential alterations to compositions stored within the container.

The weight ratio of fiber-based material layer to polymeric material layer may be at least 70:30, preferably at least 80:20, 90:10, or even 95:5. In this context a weight ratio of “at least X:Y” should be understood as encompassing any value of ratio X1:Y1 where X1≥X and where Y1≤Y. These ratios can be beneficial for the bottle/container to be processed according to various recycling streams.

Thickness of the bottle neck distal portion, including a combination of the fiber-based material and the polymeric material layer, can be at least 0.3, 0.4, 0.5, 0.6, 0.7, 1.0 millimeters or even greater. In one form, the neck distal portion has a thickness of at least 0.6 millimeters.

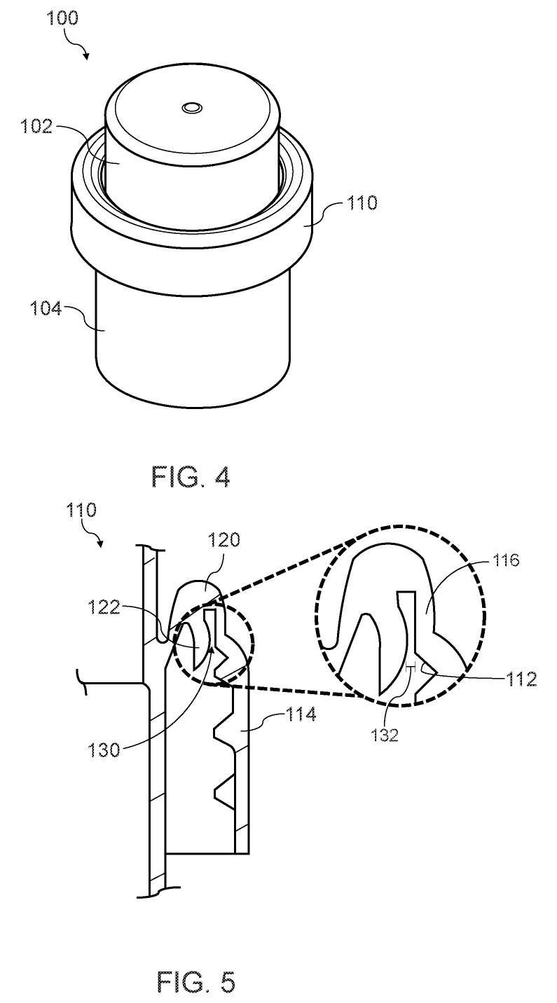

Referring now to FIGS. 4 and 5, an exemplary container cap 100 is shown. Cap 100 includes a main body portion 102, a collar member 104, and a skirt member 110. In this embodiment, collar member 104 provides flexible dispensing and dosing options. Inclusion of a collar member is optional. For example, the size and/or geometry of main body portion 102 could be enlarged to equally provide a variety of different dispensing and dosing options without a need for a collar member. The overall geometry and size of the cap is not limited to that shown and described. By way of example only, a flat-style cap can be used rather than a double-wall style cap.

Skirt member 110 comprises an inner skirt surface 112 that is oriented towards a longitudinal axis of the cap and that includes a closure thread 114 for engaging a bottle neck thread such as that described above. A bridge 120 extends radially inward from inner skit surface 112 and includes a cantilevered seal flange 122 that is spaced apart from a skirt wall 116. Skirt wall 116 provides support one side of the bottle neck distal portion when the cap is installed, particularly due to the pressure from the cantilevered seal flange 122 on an opposite side of the neck distal portion. A channel 130 is defined between cantilevered seal flange 122 and skirt wall 116. Channel 130 has a width 132, that at least in one area can expand when cantilevered seal flange 122 is deflected upon installing the cap onto the bottle. Channel width 132 typically varies even when the cap is removed from the bottle, with a channel area near bridge 120 having a greater width than a channel area towards a distal end of cantilevered seal flange 122. The channel width for use with bottles having fiber-based necks can be significantly smaller than that employed by caps for commercial plastic bottles. Channel width 132 at its narrowest point, when the cap is removed from the bottle, can be less than 0.8, 0.6, 0.55, 0.5, 0.45, 4, 0,35, or 0.3 millimeters, for example.

The cap comprises a polymeric material which can include, but is not limited to, polyolefins such as polyethylene and polypropylene. The cap polymeric material can comprise a bio-based polymer. The cap polymeric material may have a post-consumer recycled content of at least 30% by weight. It is preferred that the cap is recyclable so that entire containers provided herein can be recycled. The caps can be made by known manufacturing techniques including injection molding.

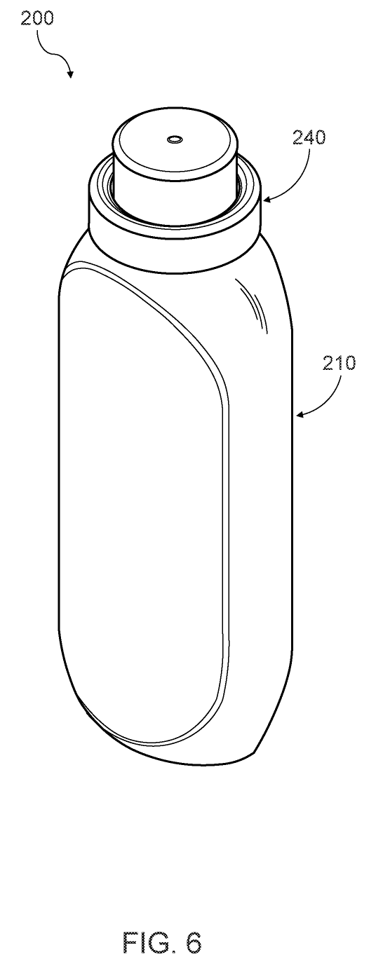

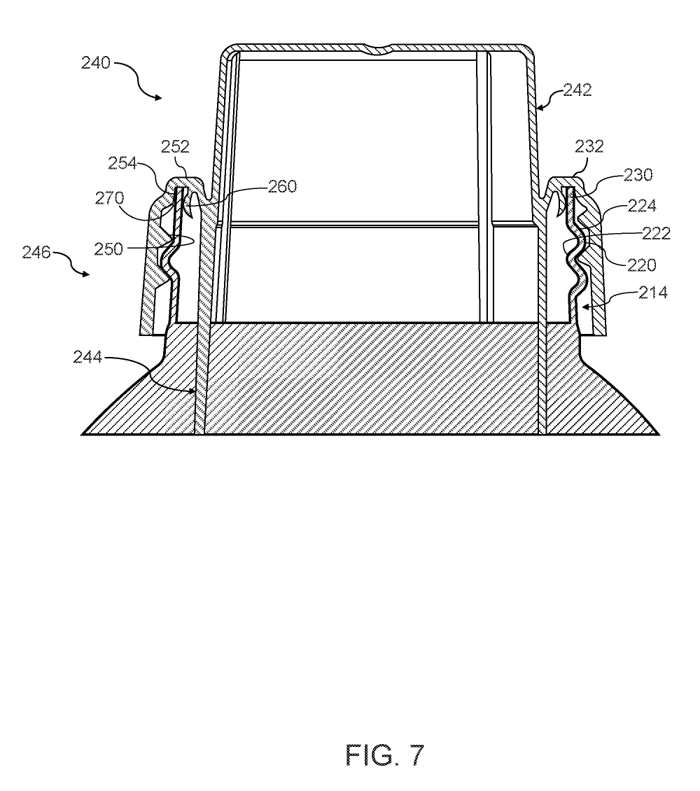

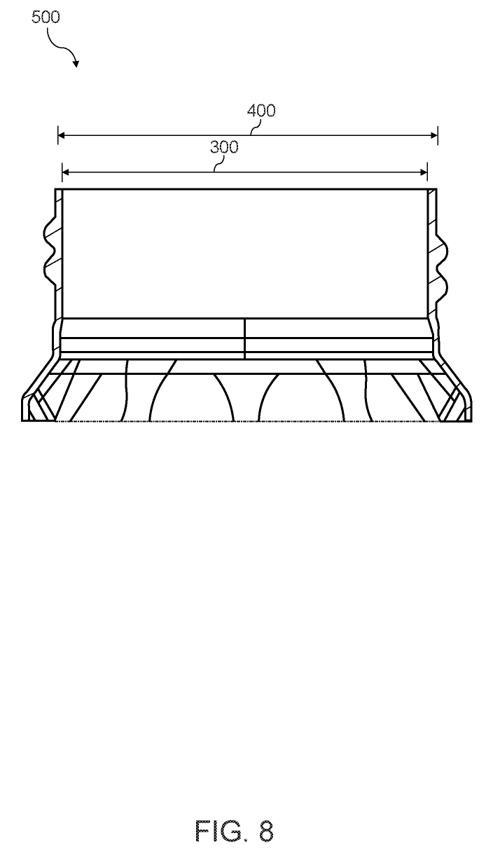

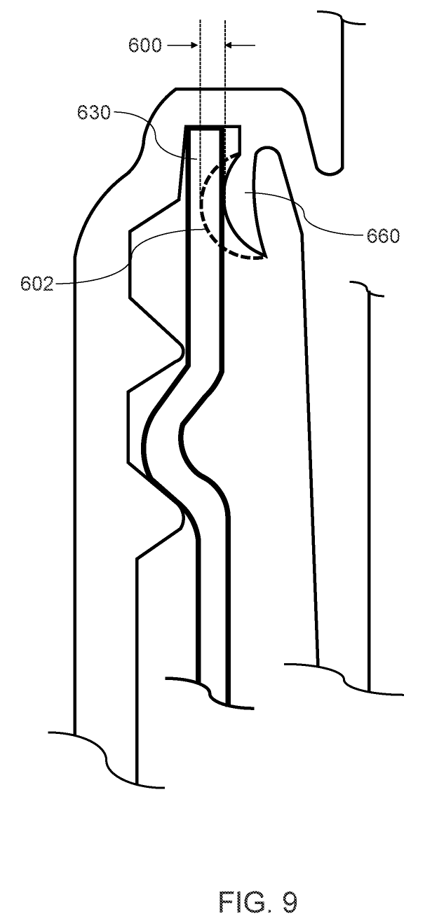

FIGS. 6 and 7 illustrate an exemplary container 200 comprising bottle 210 and cap 240. Bottle 210 includes a neck 214 comprising a neck thread 220 and neck distal portion 230 that terminates into a neck edge 232 that define a bottle opening. Note that while FIG. 7 shows neck 214 as a single layer of material, it is preferred that the bottle neck comprises both a fiber-based material layer and a polymeric material coating layer like that shown in FIGS. 2 and 3—two separate layers are not shown in FIG. 7 for simplicity reasons only. Neck thread 220 is formed such that both an inner neck surface 222 and outer neck surface 224 are curvilinear. The inner neck surface can however be linear like that shown in FIG. 8

Referring again to FIGS. 6 and 7, cap 240 comprises a main body portion 242, a collar member 244, and a skirt member 246. Skirt member 246 includes an inner skirt surface 250 and a bridge 252 that extends radially inwardly from a skirt wall 254 that forms part of inner skirt surface 250. A cantilevered seal flange 260 extends from bridge 252 and is spaced apart from skirt wall 254 to define channel 270 for receiving a bottle neck distal portion.

Properties of a bottle finish comprising a fiber-based material can vary in comparison to plastic bottle finishes. For example, the thickness of the neck distal portion of individual containers provided herein can vary as much as 1%, 2%, 3%, 5%, 10%, 15%, 20%, or 25%. One method of measuring thickness variation, with reference to FIG. 8, is by measuring an inner diameter 300 of the neck distal portion at four points around its perimeter (e.g., 0, 45, 90, 135 degrees), measuring an outer diameter 400 of the neck distal portion at two points that are separated by 45 degrees from the inner diameter measurement points (e.g., 45 and 135 degrees), subtracting the inner diameter average from the outer diameter average, and then dividing by two. Thus, for a given bottle 500, the neck distal portion 510 thickness dimension is half the difference between the outer diameter average and the inner diameter average. Amongst a plurality of containers there can be a variation of at least 15% in the thickness of the neck distal portion amongst the plurality of containers. For example, amongst a plurality of ten containers, each individual container can have a thickness of the neck distal portion around its perimeter and for the plurality of ten containers the set of those measures for the individual containers can vary by at least 15%.

Ovality of the inner and outer diameters can also be calculated from these measurements when evaluating the differences between the individual inner/outer diameter measurements. The ovality percent difference can be 1%, 2%, 3%, 5%, or even greater. In one form of the present invention, the inner diameter ovality is greater than the outer diameter ovality. In another form of the present invention, ovality of the neck distal portion is greater than ovality of the polymeric cap skirt wall that engages an outer surface of the neck distal portion.

Density of the fiber-based material within the neck region of the containers provided herein can also vary. For Example, the density of the fiber-based material along a length of the neck, particularly comparing the neck distal portion to the neck thread, can vary by as much as 2%, 3%, 5%, 6%, 7%, 8%, 9%, 10%, 12% or 15%. In one form, the neck distal portion comprises a first fiber-based material density and the neck thread comprises a second fiber-based material density that is different from the first fiber-based material density. For example, the first fiber-based material density can be greater than the second fiber-based material density. Density measurements and assessments can be made by micro-CT scanning technology or other suitable techniques.

The inventors have discovered that an appropriate “overlap” between the polymeric cap and the fiber-based neck can help enable a good container seal due to the above-mentioned property variations. Overlap is defined as the difference between a channel width dimension when the polymeric cap is removed from the bottle and a neck distal portion thickness dimension (including both the fiber-based material layer and any polymeric material coating layer). With reference to FIG. 9, an overlap 600, illustrated with a dashed line 602, exists between cantilevered seal flange 660 and neck distal portion 630. In one form, particularly when the container is used to store liquids, this overlap can be at least 0.1. 0.2, 0.3, 0.35 to about 0.50 millimeters; for example, at least 0.1 or at least 0.32 millimeters.

The containers of the present invention can be suitable for storing and dispensing liquids, particulates, or combinations thereof. In one form, the containers include a liquid formulation. The liquid composition can comprise a variety of different ingredients with a variety of different end uses and benefits. For example, the container can include a liquid composition used for fabric laundering. The liquid composition can provide various benefits, including, but not limited to, cleaning, deodorizing, sanitizing, softening, protecting (e.g., against stretch, fade and fuzz) and/or fragrancing. Exemplary liquid softening compositions can include water and a fabric softening active, such as diethylester dimethyl ammonium chloride or another quaternary ammonium compound.

### EXAMPLES AND COMBINATIONS

A. A container, comprising:

a fiber-based bottle, comprising a body and a neck, the neck comprising:

a neck thread;

a neck distal portion adjacent to the neck thread and terminating into a neck edge and bottle opening; and

a fiber-based material layer and a polymeric material layer;

a polymeric cap covering the opening and engaged with the neck, the polymeric cap comprising:

a cap thread for engaging the neck thread; and

a channel for engaging the neck distal portion.

B. The container of Paragraph A, wherein the neck comprises a curvilinear inner neck surface and an opposing curvilinear outer neck surface to define the neck thread.

C. The container of Paragraph B, wherein the neck comprises a linear inner neck surface and an opposing curvilinear outer neck surface to define the neck thread.

D. The container of any one of the preceding paragraphs, wherein the polymeric material layer comprises a first polymeric material, wherein the polymeric cap comprises a second polymeric material, and wherein the first polymeric material is different than the second polymeric material.

E. The container of Paragraph D, wherein the first polymeric material comprises polyethylene repeat units.

F. The container of Paragraph D or E, wherein the second polymeric material comprises polypropylene repeat units.

G. The container of any one of Paragraphs E to F, wherein the first polymeric material comprises a first form and the second polymeric material comprises a second form.

H. The container of Paragraph G, wherein the first form comprises polymeric powder.

I. The container of Paragraph G, wherein the first form comprises sintered polymeric particles.

J. The container of Paragraph H or I, wherein the second form comprises injection-molded polymeric material.

K. The container of any one of Paragraphs D to J, wherein the first polymeric material comprises a bio-based polymer.

L. The container of any one of Paragraphs D to K, wherein the second polymeric material comprises a bio-based polymer.

M. The container of any one of Paragraphs D to L, wherein the first polymeric material comprises 30% post-consumer recycled material.

N. The container of any one of Paragraphs D to M, wherein the second polymeric material comprises 30% post-consumer recycled material.

O. The container of any one of the preceding paragraphs, wherein the fiber-based material comprises post-consumer recycled material.

P. The container of any one of the preceding paragraphs, wherein the container is recyclable.

Q. The container of any one of the preceding paragraphs, wherein a ratio of fiber-based material to polymeric material is at least 70:30.

R. The container of any one of the preceding paragraphs, wherein the channel comprises a channel width at its narrowest point when the polymeric cap is removed from the bottle that is less than 0.6 millimeters.

S. The container of any one of Paragraphs A to Q, wherein the channel comprises a channel width at its narrowest point when the polymeric cap is removed from the bottle that is less than 0.8 millimeters.

T. The container of any one of the preceding paragraphs, wherein the neck distal portion comprises a thickness of at least 0.6 millimeters.

U. The container of any one of the preceding paragraphs, wherein a seal overlap is defined by the difference, when the polymeric cap is removed from the bottle, between a channel width dimension and a neck distal portion thickness dimension, and wherein the seal overlap is at least 0.1 millimeters.

V. The container of any one of the preceding paragraphs, wherein a seal overlap is defined by the difference, when the polymeric cap is removed from the bottle, between a channel width dimension and a neck distal portion thickness dimension, and wherein the seal overlap is at least 0.32 millimeters.

W. The container of any one of the preceding paragraphs, wherein the container is free of a removable seal that covers the opening.

X. The container of any one of the preceding paragraphs, wherein thickness of the neck distal portion varies by 1% or more.

Y. The container of any one of the preceding paragraphs, wherein the neck distal portion comprises an inner diameter ovality that is greater than an outer diameter ovality.

Z. The container of any one of the preceding paragraphs, wherein the neck distal portion comprises a first fiber-based material density and the neck thread comprises a second fiber-based material density that is different from the first fiber-based material density.

AA. The container of Paragraph Z, wherein the first fiber-based material density is greater than the second fiber-based material density.

BB. The container of any one of the preceding paragraphs, whereupon removing the polymeric cap from the bottle, the polymeric material layer in the neck is free of a permanent alteration including, but not limited to, a wrinkle, crease, crack or crimp.

CC. The container of any of the preceding paragraphs, whereupon removing the polymeric cap from the bottle, the fiber-based material in the neck is free of a permanent alteration including, but not limited to, a deformation, wrinkle, crease, or crimp.

DD. The container of any one of the preceding paragraphs, wherein the container comprises a liquid composition.

EE. The container of Paragraph DD, wherein the liquid composition comprises a fabric softening active.

FF. The container of any one of the preceding claims, wherein the container comprises solid particles.

GG. A container, comprising:

a. a fiber-based bottle, comprising a body and a neck, the neck comprising:

i. an inner neck surface and an opposing outer neck surface;

ii. a neck thread that is formed such that a portion of the outer surface is curvilinear;

iii. a neck distal portion adjacent to the neck thread and terminating into a neck edge and bottle opening; and

iv. a fiber-based material layer and a polymeric material layer; and

b. a polymeric cap covering the opening and engaged with the neck, the polymeric cap comprising:

i. a cap thread for engaging the neck thread; and

ii. a channel for engaging the neck distal portion;

c. wherein a thickness of the neck distal portion around its perimeter varies by at least 5%.

HH. The container of Paragraph GG, wherein a thickness of the neck distal portion around its perimeter varies by at least 10%.

II. The container of Paragraph GG, wherein a thickness of the neck distal portion around its perimeter varies by at least 15%.

JJ. The container of Paragraph GG, wherein the neck thread is formed such that a portion of the inner neck surface is also curvilinear.

KK. The container of Paragraph GG, wherein each container has a thickness of the neck distal portion around its perimeter, wherein amongst the plurality of containers there is a variation of at least 15% in the thickness of the neck distal portion amongst the plurality of containers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A container, comprising:
a) a fiber-based bottle, comprising a body and a neck, the neck comprising:
i) an inner neck surface and an opposing outer neck surface;
ii) a neck thread that is formed such that a portion of the outer surface is curvilinear;
iii) a neck distal portion adjacent to the neck thread and terminating into a neck edge and bottle opening; and
iv) a fiber-based material layer and a polymeric material layer; and
b) a polymeric cap covering the opening and engaged with the neck, the polymeric cap comprising:
i) a cap thread for engaging the neck thread; and
ii) a channel for engaging the neck distal portion;
c) wherein the polymeric material layer covers the fiber-based material to define the inner neck surface and the neck edge; and
d) wherein the polymeric material layer comprises a first polymeric material, wherein the polymeric cap comprises a second polymeric material, and wherein the first polymeric material is different than the second polymeric material.

2. The container of claim 1, wherein the polymeric material layer also covers the fiber-based material to define the outer neck surface.

3. The container of claim 1, wherein the first polymeric material comprises polyethylene repeat units.

4. The container of claim 1, wherein the second polymeric material comprises polypropylene repeat units.

5. The container of claim 1, wherein the first polymeric material comprises a first form and the second polymeric material comprises a second form that is different from the first form.

6. The container of claim 5, wherein the first form comprises polymeric powder and the second form comprises injection-molded polymeric material.

7. The container of claim 1, wherein at least one of the first polymeric material and the second polymeric material comprises a bio-based polymer.

8. The container of claim 1, wherein the second polymeric material comprises at least 30% post-consumer recycled material.

9. The container of claim 1, wherein the first polymeric material comprises at least 30% post-consumer recycled material.

10. The container of claim 1, wherein the fiber-based material comprises post-consumer recycled material.

11. A plurality of containers according to claim 1, wherein each container has a thickness of the neck distal portion around its perimeter, wherein amongst the plurality of containers there is a variation of at least 15% in the thickness of the neck distal portion amongst the plurality of containers.

12. The container of claim 1, wherein the container is free of a removable seal that covers the opening.

13. The container of claim 1, wherein the neck thread is formed such that a portion of the inner neck surface is also curvilinear.

14. A container, comprising:
a) a fiber-based bottle, comprising a body and a neck, the neck comprising:
i) an inner neck surface and an opposing outer neck surface;
ii) a neck thread that is formed such that a portion of the outer surface is curvilinear;
iii) a neck distal portion adjacent to the neck thread and terminating into a neck edge and bottle opening; and
iv) a fiber-based material layer and a polymeric material layer; and
b) a polymeric cap covering the opening and engaged with the neck, the polymeric cap comprising:
i) a cap thread for engaging the neck thread; and
ii) a channel for engaging the neck distal portion, the channel comprising a cantilever seal;
c) wherein a seal overlap is defined by the difference, when the polymeric cap is removed from the bottle, between a channel width dimension and a neck distal portion thickness dimension, and wherein the seal overlap is at least 0.1 millimeters.

15. The container of claim 14, wherein the seal overlap is at least 0.32 millimeters.

16. The container of claim 14, wherein the polymeric cap comprises a second polymeric material that is different than the polymeric material associated with the polymeric material layer of the bottle.

17. The container of claim 14, wherein a ratio of fiber-based material to polymeric material is at least 70:30.

18. The container of claim 14, wherein the container is free of a removable seal that covers the opening.

19. The container of claim 14, wherein the neck thread is formed such that a portion of the inner neck surface is also curvilinear.

20. A container, comprising:
a) a fiber-based bottle, comprising a body and a neck, the neck comprising:
i) an inner neck surface and an opposing outer neck surface;
ii) a neck thread that is formed such that a portion of the outer surface is curvilinear;
iii) a neck distal portion adjacent to the neck thread and terminating into a neck edge and bottle opening; and
iv) a fiber-based material layer and a polymeric material layer; and
b) a polymeric cap covering the opening and engaged with the neck, the polymeric cap comprising:
i) a cap thread for engaging the neck thread; and
ii) an expandable channel for engaging the neck distal portion;
c) wherein the channel comprises a channel width at its narrowest point when the polymeric cap is removed from the bottle that is less than 0.8 millimeters.
